(19) United States
(12) Patent Application Publication
(10) Pub. No.: US 2018/0008507 A1
(43) Pub. Date: Jan. 11, 2018

(54) MASSAGE CELL ARRANGEMENT AND MASSAGE CELL SYSTEM

(71) Applicant: Kongsberg Automotive AB, Mullsjo (SE)

(72) Inventors: Jari Sarén, Norrahammar (SE); Ronny Norman, Habo (SE); Daniel Josefsson, Falkoping (SE)

(21) Appl. No.: 15/643,107

(22) Filed: Jul. 6, 2017

(30) Foreign Application Priority Data
Jul. 7, 2016 (SE) 1651007-5

(51) Int. Cl. A61H 9/00; B60N 2/44

(52) U.S. Cl. CPC A61H 9/0078; B60N 2/448; A61H 2201/0103; A61H 2201/1623; A61H 2201/1238; A61H 2203/0431; A61H 2201/1654

(57) ABSTRACT

A massage cell arrangement comprising a plurality of inflatable/deflatable cells arranged in a first series of successive cells, a plurality of inflatable/deflatable cells arranged in a second series of successive cells, the cells of a series of successive cells being substantially aligned along the main direction of extension of the series of successive cells, the first and second series being aligned such that the main direction of extension of the first series coincides with the main direction of extension of the second series, the first and second series being arranged such that two successive cells of the first series together cover 10-100% of a major surface area of a cell of the second series and wherein each of said two successive cells of the first series cover 5-95% of the major surface area of said cell of the second series.

### CROSS REFERENCE TO RELATED APPLICATIONS

This application claims priority to Swedish Patent Application No. 1651007-5, filed Jul. 7, 2016, the entire disclosure of both of which are incorporated herein by reference

### TECHNICAL FIELD

The present invention relates to a massage cell arrangement and a massage cell system comprising such massage cell arrangement.

### BACKGROUND

Massage systems for vehicle seats may comprise a linear sequence of successive inflatable massage cells which are arranged along the seat below the inner surface of the cover of the seat wherein the cells are sequentially inflated/deflated for carrying out a massage function. U.S. Pat., No. 5,135,282 A shows such a massage cells system. By means of a number of controllable valves a propagating sequential inflation along a series of spaced apart air cells starting from the first cell at the lower end of the seat back and continuing cell by cell to the last cell at the upper end of the seat is performed. After all air cells have been inflated a venting line with controllable valves in a corresponding manner sequentially deflates the air cells in the series of air cells starting with the first air cell and then continuously cell by cell until all cells are deflated. The inflation/deflation of the air cells causes a deformation in the backrest which propagates in a wave-like manner.

US 2014/0207333 A1 discloses a massage device which in the lumbar region has three partially overlapping massage cells located below the seat cover padding. The massage effect achieved is, however, limited due to the position below the seat cover padding.

There is a demand for improved seat massage systems which provides a person seated in the seat with a more continuous and intensified massage experience.

### SUMMARY

It is an object of the present disclosure to provide an improved or at least an alternative massage cell arrangement for a vehicle seat and a massage system comprising such massage cell arrangement.

The invention is defined by the appended independent claims with embodiments being set forth in the appended dependent claims, in the following description and in the drawings.

According to a first aspect, there is provided a massage cell arrangement comprising a plurality of inflatable/deflatable cells arranged in a first series of successive cells, a plurality of inflatable/deflatable cells arranged in a second series of successive cells, each cell having a first and a second major surface arranged on substantially opposite sides of the cell, the cell being configured for connection with a fluid system for inflation/deflation of the cell, a surface normal of a major surface of a deflated cell being substantially orthogonal to a main direction of extension of the series of successive cells and wherein the cells of a series of successive cells are substantially aligned along the main direction of extension of the series of successive cells. The first and second series of successive cells being aligned such that the main direction of extension of the first series of successive cells substantially coincides with the main direction of extension of the second series of successive cells, the first and second series of successive cells being arranged such that two successive cells of the first series of successive cells together cover 10-100% of a major surface area of a cell of the second series of successive cells and wherein each of said two successive cells of the first series of successive cells cover 5-95% of the major surface area of said cell of the second series of successive cells.

The cells of a series of successive cells may be arranged and oriented in substantially the same way. The cells of the massage cell arrangement may have the same shape and size. Alternatively, at least some the cells may differ from the other cells with regard to size and shape.

The first and second surfaces of a cell are connected along the periphery to form an inflatable/deflatable cell. The cell may be provided with an opening for connection with the fluid system for inflation/deflation of the cell.

The number of cells in a series of successive cells may be 2-50, 2-40, 2-30, 2-20, 2-10, 5-50, 5-40, 5-30, 5-20, 5-10, 10-50, 10-40, 10-30, 10-20, 20-50, 20-40, 20-30, 30-50 or 30-40. The number of cells in the first and second series of successive cells could be the same or could be different. Preferably, a difference in number of cells is less than 20%.

That the cells of the first and second series of cells cover each other could here mean that they are in direct contact with each other at the area of coverage. Alternatively, e.g. a sheet material or support structure may be arranged between the first and second series of successive cells such that the cells thereof are not in direct contact with each other.

That a surface normal of a major surface of a deflated cell is substantially orthogonal to the main direction of extension of the series of successive cells is here meant that the surface normal may deviate from the main direction of extension with 90±30°.

That the cells of a series of successive cells are substantially aligned along the main direction of extension of the series of successive cells is here meant that a centre point of a cell may deviate from the main direction of extension with 0-50%, preferably less than 20%, of a smallest length of a major surface of the massage cell in a direction orthogonal to the main direction of extension.

That the main directions of extension of the first and second series of successive cells substantially coincide is here meant that they are substantially parallel and deviate less than or about 15°. Further, a central line drawn through the centre of the first series of successive cells in the main direction of extension of the first series of cells substantially coincides with a corresponding central line of the second series of cells. The central lines may be offset in relation to each other 0-50%, preferably less than 20%, of a length of a smallest massage cell used in the massage cell arrangement in a direction of extension orthogonal to the main direction of extension. Differently expressed, the first and second series of successive cells may be arranged substantially on top of each other.

The massage cell arrangement may be arranged directly underneath the seat cover of a seat. It could e.g. be arranged in the back of the seat or in the seat cushion. The seat could be the seat of a vehicle or a seat not arranged in a vehicle, such as e.g. a rest chair.

The massage cell arrangement may be positioned in the seat in such a way that the cells of the first series of successive cells are closer to the seat cover than the cells of the second series of successive cells, as the cells of the first series of successive cells at least partly cover the major surfaces of the cells of the second series of successive cells.

The fluid used for inflating the massage cells is typically a gas, such as ambient air or any other suitable fluid.

In a series of successive cells the cells may be substantially linearly arranged, or alternatively slightly offset from the main direction of extension of the cells.

Inflation of the cells takes place along the two series of cells in a wave-like manner and results in a movement along the main extension of the series of cells such that a wave-like and smooth massage feeling is experienced by a person seated in a seat in which the massage cell arrangement is installed.

The cells of the series of cells could be inflated in either direction, i.e. the first or last cell in a series of successive cells could be the first cell to be inflated.

During inflation of the massage cell arrangement the order of inflation is such that for two successive cells of the first series of successive cells, which together cover 10-100% of a major surface area of a cell of the second series of successive cells, a first one of the cells of the first series of cells is inflated, thereafter the cell of the second series of cells is inflated and finally the second cell of the first series of cells is inflated, and so on along the main extension of the series of cells. In other words every other cell which is inflated is from the first series of cells and every other cell which is inflated is from the second series of cells. The inflation moving along the main extension of the two series of cells.

In the area of coverage of cells from the first and second series of cells the combined stroke is larger than for cells not covered by any other cells. Hence, the pressure against the seat is greater than for non-covered cells.

It is not necessary that a particular cell is fully inflated when the next cell starts to be filled. Further, it is not necessary that the cells are fully inflated. For example, an inflation corresponding to 70-90%, e.g. 80%, of the volume fill capacity of the cell may be sufficient. The delay time between a first cell reaching 70-90% of its volume fill capacity and a second cell reaching 70-90% of its volume fill capacity may be between 0.5 and 30 seconds, preferably 0.5-10 s.

Two successive cells of the first series of successive cells together may cover 20-100%, 30-100%, 40-100%, 50-100%, 60-100%, 70-100%, 80-100%, 90-100%, 20-90%, 30-90%, 40-90%, 50-90%, 60-90%, 70-90%, 80-90%, 20-80%, 30-80%, 40-80%, 50-80%, 60-80%, 70-80%, 20-70%, 30-70%, 40-70%, 50-70%, 60-70%, 20-60%, 30-60%, 40-60%, 50-60%, 20-50%, 30-50%, 40-50%, 20-40%, 30-40% or 20-30% of a major surface area of a cell of the second series of successive cells.

Two successive cells in a series of successive cells may be arranged at a distance from each other in the main direction of extension of the series of successive cells, the distance being 0-90% of a length of a major surface of a smallest cell in the series of successive cells in the main direction of extension of the series of cells.

Hence, two successive cells in the series of successive cells may be arranged to be in contact with each other, i.e. a distance of approximately 0%.

The distance between two successive cells may be 0-10%, 10-20%, 20-30%, 30-40%, 40-50%, 50-60%, 60-70% or 80-90% of a length of a major surface of a smallest cell.

All cells in a series of cells may be the same kind of cells having the same shape and dimensions. The cells may alternatively be of different size and shape. In such a case the distance between two successive cells may be 0-90% of a length of a major surface of a smallest cell used in the massage cell arrangement.

Cells of the first and second series of cells which are arranged to cover each other may be directly connected to each other at a portion of the area of coverage.

Thereby, the cells are held and kept in their positions in the first/second series of successive cells and in the massage cell arrangement. If at least partly made of weldable material, the cells may be connected to each other by means of welding. Alternatively, they may be connected to each other by means of gluing etc.

Alternatively, the massage cell arrangement may comprise a support structure having a first and second major surface arranged on substantially opposite sides of the support structure, wherein the cells of the first series of successive cells may be arranged on the first major surface of the support structure, and the cells of the second series of successive cells may be arranged on the second major surface of the support structure.

The support structure may be a flexible sheet material such that inflation of cells is not obstructed by the support structure and such that the support structure conforms to a change of shape of the cells during inflation/deflation thereof.

The cells may be oriented in the same way on the support structure.

The massage cells may be connected to the first or second major surface of the support structure through at least a portion of their first or second major surface.

The cells may be directly connected to the support structure by means of welding (if the support structure and the cell at least partly are made of weldable material), gluing etc.

The massage cell arrangement may in an alternative embodiment comprise a sheet material provided with a plurality of pockets one for each individual cell of the first and second series of successive cells.

Thereby, the cells are held and kept in their positions in the first/second series of successive cells and in the massage cell arrangement. With the use of such a sheet material there is no need for welding or gluing of the cells.

The sheet material may substantially or partly be made of plastics.

The cells may substantially or partly be made of plastics.

The support structure may substantially or partly be made of plastics.

The plastic material may be a plastic film, foil or sheet. The plastic material could e.g. be polyethylene, polypropylene, polyester, polyvinyl chloride or polyurethane. In one example the plastic material is thermoplastic polyurethane (TPU) foil.

The support structure may be made of different materials and of different plastics. For example could a first major surface of the support structure be of a first material and the second major surface be of a second material.

The sheet material may be flexible such that inflation of the cells is not obstructed by the sheet material and such the sheet material conforms to a change of shape of the cells during inflation/deflation thereof. The sheet material may be superimposed sheets which are connected/welded together to form said pockets.

The plastic material for the sheet material and the cells may be any one of the plastic materials discussed above.

For the massage cell the material should be sealable to form the cell and facilitate the increase in volume of the cell as the cell is filled with fluid.

The cell may be made of different materials and of different plastics. For example could a first major surface of the cell be of a first material and the second major surface be of a second material.

The first and/or second series of cells may comprise massage cells which are curved in the deflated condition such that the cells present a generally convex first major surface.

A surface normal of the generally convex first major surface is pointing away from the cell.

In a preferred embodiment the curved cell exhibits a complementary generally concave second major surface arranged on the opposite side of the cell from the convex first major surface.

That the cell is curved in the deflated condition means that also after a plurality of inflations/deflations the cell remains substantially curved in its deflated condition.

Depending on the degree of inflation, the cells may or may not present any curvature in the inflated condition.

In the cell arrangement when placed under the cover of a seat a surface normal of the convex surface should be arranged to point towards the cover.

When placed underneath the cover there is less seat show through with a curved cell than with planar fluid cells, as the edges of the cell are arranged inwards pointing away from the trim. Hence, there is also less wear on the seat cover from edges of the cells compared to planar cells.

Alternatively, the cells may be substantially planar.

The cells may be multi-cells comprising at least two connected sub-cells arranged on top of each other, the multi-cell comprising at least a base sub-cell and a top sub-cell, wherein internal spaces of the massage cells in the multi-cell are in fluid communication with each other.

The base sub-cell of a multi-cell is fully inflated slightly before the top sub-cell and any intermediate sub-cell of a multi-cell, as fluid from the fluid system first enters the base sub-cell and thereafter flows to any intermediate sub-cell and to the top sub-cell. A sub-cell is substantially the same kind of cell as a single cell.

The stroke during inflation of a multi-cell is larger than the stroke of a single cell and, hence, the pressure by each multi-cell against e.g. the back of someone seated in the seat, in which a massage cell arrangement comprising multi-cells is installed, is greater than when single cells are used.

According to a second aspect there is provided a massage system comprising the massage cell arrangement described above and a fluid system for sequential inflation/deflation of the cells of the massage cell arrangement.

The inflation/deflation of the massage system being as describe above for the massage cell arrangement.

According to a third aspect there is provided a massage system comprising two of the massage cell arrangements described above arranged such that their main directions of extension are substantially parallel and such that first massage cells of the two massage cell arrangements form a first pair of massage cells, and further comprising a fluid system for sequential inflation/deflation of the cells of the massage cell arrangement and for substantially simultaneous inflation/deflation of a pair of cells formed by the two massage cell arrangements.

The cell arrangements in the massage system may be arranged spaced apart or adjacent to each other. A distance between the cell arrangements may be adapted to where the cell system is to be positioned in the seat, the massage feeling wanted, the fluid system used etc.

First cells of the two massage cell arrangements form a first pair of cells, second cells form a second pair of cells etc.

The fluid system may comprise a plurality of fluid connections, each fluid connection being connected to a pair of fluid cells.

The fluid system may be connected to or at least partly be incorporated in the support structure.

If the support structure is made of plastics fluid connections may be formed in the support structure by means of welding.

All cells may be connected to the same support structure.

The cells may be connected to the support structure in such a way that cells of a first series of successive cells of each massage cell arrangement may be connected to a first major surface and cells of a second series of successive cells of each massage cell arrangement may be connected to a second major surface of the support structure.

### BRIEF DESCRIPTION OF THE DRAWINGS

FIG. 1 shows a cross-section of a massage cell arrangement.

FIG. 2 shows a cross-section of an alternative massage cell arrangement.

FIG. 3 shows a massage system comprising two of the massage cell arrangements shown in FIG. 1 connected to the same support structure and the same fluid system.

FIG. 4 shows a curved massage cell.

### DETAILED DESCRIPTION

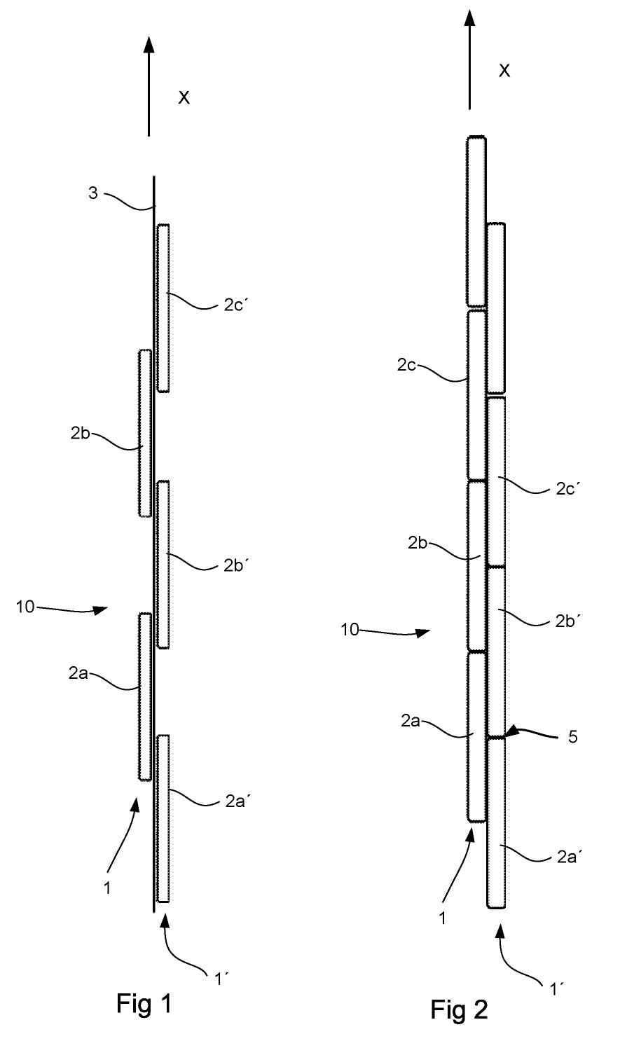

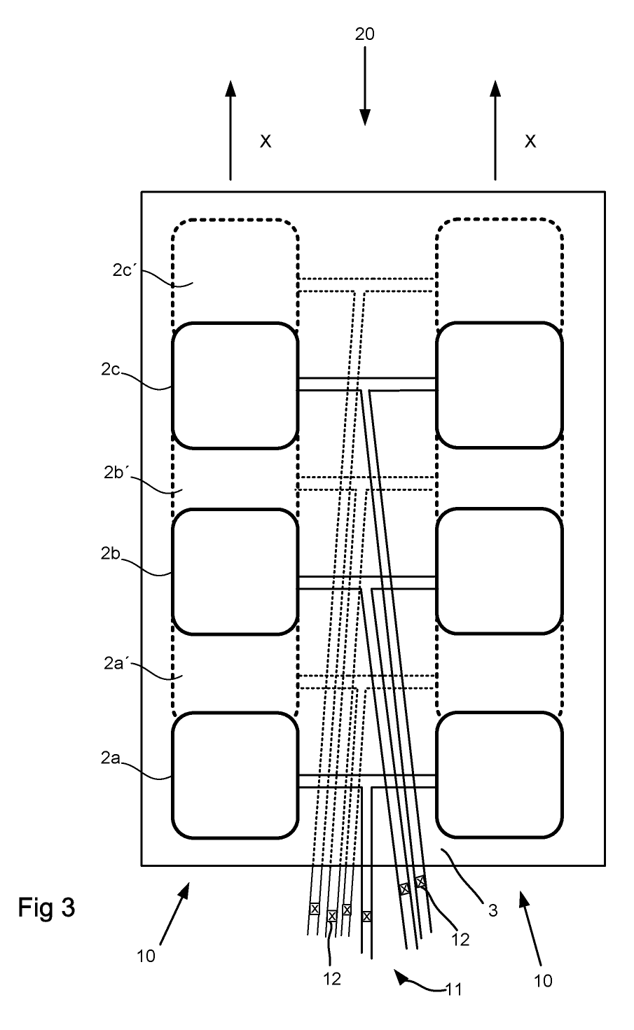

In FIGS. 1 and 2 are shown cross-sections of two massage cell arrangements 10, both arrangements having a first series 1 of a plurality of successive inflatable/deflatable cells 2a, 2b, 2c and a second series 1′ of a plurality of successive inflatable/deflatable cells 2a′, 2b′, 2c′. The first and second series of successive cells 1, 1′ being aligned such that the main directions of extension X of the two series of cells substantially coincide. Each cell 2a, 2b, 2c, 2a′, 2b′, 2c′ has a first and second major surface arranged on substantially opposite sides of the cell. Each cell 2a, 2b, 2c, 2a′, 2b′, 2c′ has an opening (not shown) for connection with a fluid system such that the cell may be inflated/deflated. The cells 2a, 2b, 2c, 2a′, 2b′, 2c′ are arranged in the first and second series of cells 1, 1′ such that a surface normal of a major surface of a cell in deflated condition is substantially orthogonal to the main direction of extension X of the series of successive cells 1, 1′. The two series of cells 1, 1′ are arranged substantially on top of each other and such that two successive cells 2a, 2b of the first series of successive cells 1 together cover 10-100% of a major surface area of a cell 2b′ of the second series of successive cells 1′ and each of the two successive cells 2a, 2b of the first series of successive cells 1 cover 5-95% of the major surface area of the cell 2b′ of the second series of successive cells 1′.

In the example shown in FIG. 1, two cells 2a, 2b of the first series of successive cells 1 together cover approximately 40% of a cell 2b ‘of the second series of successive cells 1’. Two successive cells 2a′, 2b′ of the second series of successive cells together cover approximately 40% of a cell 2a of the first series of successive cells 1.

In FIG. 2, two successive cells 2a, 2b of the first series of successive cells 1 together cover approximately 100% of a cell 2b′of the second series of successive cells 1′. Two successive cells 2a′, 2b′ of the second series of successive cells together cover approximately cover 100% of a cell 2a of the first series of successive cells 1.

In FIG. 1 two successive cells 2a, 2b; 2a′, 2b′ in a series of successive cells 1, 1′ are arranged at a distance from each other in the main direction of extension X of the series of successive cells. The distance being about 60% of the length of a major surface of a cell in the main direction of extension of the series of cells. Other distances between successive cells are possible and may be 0-90% of the length of a major surface of a smallest cell in the series of successive cells 1, 1′ in the main direction of extension of the series of cells.

In FIG. 2 two successive cells 2a, 2b; 2a′, 2b′ in the series of successive cells 1, 1′ are arranged to be in contact with each other, i.e. a distance of approximately 0%.

All cells in a series of cells 1, 1′ may be the same kind of cells having the same shape and dimensions. The cells 2a, 2b, 2c, 2a′, 2b′, 2c′ may alternatively be of different size and shape.

The distances between successive cells 2a, 2b; 2a′, 2b′ in a series of cells may not be the same but may vary along the extension of the series of successive cells (not shown).

In the arrangements shown in FIGS. 1 and 2 the coverage of cells is symmetric. It is possible, however, that two cells 2a, 2b of a first series of cells 1 does not cover equally much of a cell 2b′ of the second series of cells 1′ and vice versa.

The massage cells 2a, 2b, 2a′, 2b′ of the first and second series of cells 1, 1′ of the arrangements of FIGS. 1 and 2, which cells are arranged to cover each other, may be directly connected to each other at a portion of the area of coverage, such that the cells are held together in the series of successive cells 1, 1′.

The cells of the massage cell arrangement may alternatively not be in direct contact with each other and the massage cell arrangement may comprise a support structure 3 having a first and second major surface arranged on substantially opposite sides of the support structure. In FIG. 1 the cells 2a, 2b, 2c of the first series of successive cells 1 are arranged on the first major surface of a support structure 3, and the cells 2a′, 2b′, 2c′ of the second series of successive cells 1′ are arranged on the second major surface of the support structure 3, i.e. the cells are arranged on opposite sides of the support structure and may be connected thereto through at least a portion of their first or second major surface.

In FIG. 2 each individual cell 2a, 2b, 2c, 2a′, 2b′, 2c′ of the first and second series of successive cells 1, 1′ is arranged in a respective pocket provided in a sheet material 5. The sheet material 5 having a plurality of pockets, one for each cell.

It is possible that the arrangement of FIG. 1 could be placed in a sheet material with a pocket for each cell. It is possible that the first and second series of successive cells 1, 1′ of the massage cell arrangement 1, 1′ of FIG. 2 could be arranged on opposite sides of a support structure 3.

The massage cells may be welded to each other or to the support structure.

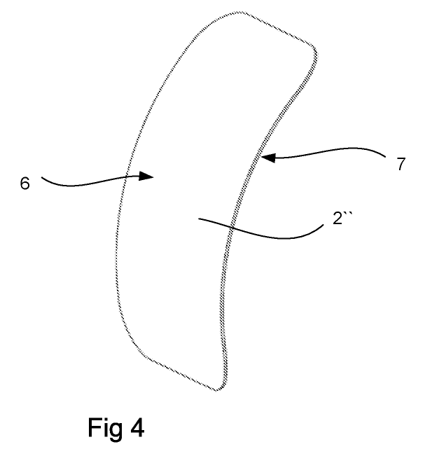

The massage cells used in the massage cell arrangement may be substantially planar. Alternatively, the first and/or second series of cells may comprise cells which are curved in the deflated condition, see FIG. 4, such that the cells present a generally convex first major surface 6. The curved cell may also present a complementary generally concave second major surface 7.

In a non-shown embodiment, the cells 2a, 2b, 2c, 2a′, 2b′, 2c′, 2″ are multi-cells comprising at least two connected sub-cells arranged on top of each other, the multi-cell comprising at least a base sub-cell and a top sub-cell wherein internal spaces of the sub-cells in the multi-cell are in fluid communication with each other.

Major surfaces of a massage cell and/or sub-cell in deflated condition may be substantially polygonal, semi-polygonal, round or oval. Examples of such polygonal or semi-polygonal surfaces comprise triangular, rectangular, square, diamond-like, pentagonal, hexagonal, heptagonal, octagonal configuration, nonagonal, decagonal surfaces etc. Corners may be round or sharp.

All cells and sub-cells in a series of successive cells may have the same shape. Alternatively, at least some of the cells and/or sub-cells may have different shapes. Preferable at least the sub-cells of a multi-cell have the same shape.

The massage cell arrangements of FIGS. 1 and 2 are connected to a fluid system 11 (not shown in FIGS. 1 and 2) arranged for sequential inflation/deflation of the massage cells 2a, 2b, 2c, 2a′, 2b′, 2c′ in the arrangement 10, forming a massage cell system. During inflation of the massage cell arrangement the order of inflation is such that for two successive cells 2a, 2b of the first series of successive cells 1, which together cover 10-100% of a major surface area of a cell 2b′ of the second series of successive cells 1′, a first one of the cells 2a of the first series of cells 1 is inflated, thereafter the cell 2b′ of the second series of cells 1′ is inflated and finally the second cell 2b of the first series of cells 1 is inflated, and so on along the main extension X of the series of cells. In other words every other cell which is inflated is from the first series of cells 1 and every other cell which is inflated is from the second series of cells 2. The inflation moving along the main extension X of the two series of cells.

In FIG. 3 a massage cell system 20 is shown comprising two of the cell arrangements of FIG. 1. The massage cell system could equally well comprise two of the massage cell arrangements shown in FIG. 2, or alternatively one cell arrangement of FIG. 1 and one cell arrangement of FIG. 2. The two cell arrangements are substantially parallel and aligned such that their main directions of extension X are substantially parallel and such that first massage cells 2a, 2b, 2c, 2a′, 2b′, 2c′ of the two massage cell arrangements 10 form a first pair of massage cells. The two massage cell arrangements 10 may be connected to the same support structure 3 and to the same fluid system 11 such that a pair of cells formed by the two massage cell arrangements 1, 1′ is substantially simultaneously inflated/deflated.

The fluid system may be connected to or, if of weldable material, at least partly incorporated in the support structure. Inflation of the massage cells 2a, 2b, 2c, 2a′, 2b′, 2c′ takes place along the series of fluid cells in a wave-like manner and results in a movement along the extension of the series of fluid cells 1, 1′. The cells of the series of cells could be inflated in either direction.

The fluid system 11 is connected to a pump for supplying fluid under pressure to the fluid system (not shown). Controllable valves 12, FIG. 3, are arranged in the fluid and arranged and controlled in such a way that sequential inflation/deflation of the cells/pairs of cells in the series of successive cells 1, 1′ as described above may be obtained. Such controllable valves are for example shown in U.S. Pat. No. 5,153,282.

The massage cell system 20 may further comprise venting means for venting the fluid system 11 (not shown). The massage cell system 20 may further comprise a control unit or switch for controlling the operation of the pump (not shown).

1. A massage cell arrangement comprising:
a plurality of inflatable/deflatable cells arranged in a first series of successive cells;
a plurality of inflatable/deflatable cells arranged in a second series of successive cells;
each cell having a first and a second major surface arranged on substantially opposite sides of the cell, the cell being arranged for connection with a fluid system for inflation/deflation of the cell, a surface normal of a major surface of a deflated cell being substantially orthogonal to a main direction of extension of the series of successive cells;
the cells of a series of successive cells being substantially aligned along the main direction of extension of the series of successive cells;
the first and second series of successive cells being aligned such that the main direction of extension of the first series of successive cells substantially coincides with the main direction of extension of the second series of successive cells, the first and second series of successive cells being arranged such that two successive cells of the first series of successive cells together cover 10-100% of a major surface area of a cell of the second series of successive cells and wherein each of said two successive cells of the first series of successive cells cover 5-95% of the major surface area of said cell of the second series of successive cells.

2. The massage cell arrangement of claim 1, wherein two successive cells in a series of successive cells are arranged at a distance from each other in the main direction of extension of the series of successive cells, the distance being 0-90% of a length of a major surface of a smallest cell of the series of successive cells in the main direction of extension of the series of cells.

3. The massage cell arrangement of claim 2, wherein cells of the first and second series of cells which are arranged to cover each other are directly connected to each other at a portion of the area of coverage.

4. The massage cell arrangement of claim 2, further comprising a support structure having a first and second major surface arranged on substantially opposite sides of the support structure, wherein the cells of the first series of successive cells are arranged on the first major surface of the support structure, and the cells of the second series of successive cells are arranged on the second major surface of the support structure.

5. The massage cell arrangement of claim 4, wherein the cells are connected to the first or second major surface of the support structure through at least a portion of their first or second major surface.

6. The massage cell arrangement of claim 2, further comprising a sheet material provided with a plurality of pockets one for each individual cell of the first and second series of successive cells.

7. The massage cell arrangement of claim 6, wherein the first or second series of cells comprise cells which are curved in the deflated condition such that the cells present a generally convex first major surface.

8. The massage cell arrangement of claim 7, wherein the cells are multi-cells comprising at least two connected sub-cells arranged on top of each other, the multi-cell comprising at least a base sub-cell and a top sub-cell, wherein internal spaces of the sub-cells in the multi-cell are in fluid communication with each other.

9. The massage cell arrangement of claim 8, wherein two successive cells of the second series of successive cells together cover 10-100% of a major surface area of a cell of the first series of successive cells, and each of said two successive cells of the second series of successive cells cover 5-95% of the major surface area of said cell of the first series of successive cells.

10. A massage system comprising the massage cell arrangement of claim 9, further comprising a fluid system for sequential inflation/deflation of the cells of the massage cell arrangement.

11. A massage system comprising two of the massage cell arrangements of claim 9 arranged such that their main directions of extension are substantially parallel and such that first massage cells of the two massage cell arrangements form a first pair of massage cells, and further comprising a fluid system for sequential inflation/deflation of the cells of the massage cell arrangement and for substantially simultaneous inflation/deflation of a pair of cells formed by the two massage cell arrangements.

12. The massage system of claim 11, wherein the fluid system is connected to or partly is incorporated in the support structure.

13. The massage system of claim 12, wherein all massage cells are connected to the same support structure.
